(19) United States
(12) Patent Application Publication
(10) Pub. No.: US 2023/0108027 A1
(43) Pub. Date: Apr. 6, 2023

(54) AGRICULTURAL PRODUCT PLACEMENT SYSTEM USING MACHINE LEARNING

(71) Applicant: Benson Hill Holdings, Inc., St. Louis, MO (US)

(72) Inventors: Dylan C. Kesler, St. Louis, MO (US); Matthew B. Crisp, Olivette, MO (US); Jason K. Bull, Wildwood, MO (US); Paul Skroch, St. Louis, MO (US); Sara J. Anderson, Alexandria, MN (US)

(21) Appl. No.: 17/961,145

(22) Filed: Oct. 6, 2022

Related U.S. Application Data
(60) Provisional application No. 63/252,852, filed on Oct. 6, 2021.

(51) Int. Cl. G06Q 10/08; G06Q 50/02; A01B 79/00

(52) U.S. Cl. CPC G06Q 10/0833; G06Q 50/02; A01B 79/005

(57) ABSTRACT

Methods of determining apportionments for agricultural products (e.g., fixed amounts of seed) to one or more growing locations (e.g., agricultural fields) for a first growing season based upon growing performances of at least one of first growing locations or second growing locations different from or overlapping with the first growing locations can include remotely collecting intrinsic and extrinsic attributes for the second growing locations, the extrinsic attributes for a second growing season prior to the first growing season, determining aggregate commercial desirabilities for crop samples grown in the second growing locations, normalizing the aggregate commercial desirabilities to establish commercial desirability indices, training a controller to identify a subset of attributes selected from the intrinsic and extrinsic attributes and correlated with the commercial desirability indices, remotely collecting intrinsic and extrinsic attributes for the first growing locations, and predicting commercial desirability indices for the first growing locations based upon the identified attributes.

### CROSS-REFERENCE TO RELATED APPLICATIONS

The present application claims the benefit under 35 U.S.C. § 119(e) of U.S. Provisional Application Ser. No. 63/252,852, filed Oct. 6, 2021, and titled “AGRICULTURAL PRODUCT PLACEMENT SYSTEM USING MACHINE LEARNING,” which is herein incorporated by reference in its entirety.

### BACKGROUND

Generally, the term “machine learning” refers to computer algorithms that can improve through experience and the use of data. For example, machine learning can be used to model an environment based on sample or training data and then make decisions or predictions without explicit instructions. Deep learning or deep structured learning is a type of machine learning that can use artificial neural networks (e.g., inspired by biological systems) with representation learning.

### DRAWINGS

The Detailed Description is described with reference to the accompanying figures. The use of the same reference numbers in different instances in the description and the figures may indicate similar or identical items.

FIG. 1 is a block diagram illustrating a system for determining apportionments for agricultural products (e.g., fixed amounts of seed) to one or more growing locations (e.g., agricultural fields) based upon data collected from various sources, such as one or more sensors, where the system is connected to a client device via a network in accordance with example embodiments of the present disclosure.

FIG. 2 is another block diagram of the system connected to the network as shown in FIG. 1.

FIG. 3 is a block diagram illustrating sensors for a system for determining apportionments for agricultural products to growing locations, such as the system illustrated in FIG. 1, in accordance with example embodiments of the present disclosure.

FIG. 4 is a block diagram illustrating intrinsic attributers for a system for determining apportionments for agricultural products to growing locations, such as the system illustrated in FIG. 1, in accordance with example embodiments of the present disclosure.

FIG. 5 is a block diagram illustrating extrinsic attributers for a system for determining apportionments for agricultural products to growing locations, such as the system illustrated in FIG. 1, in accordance with example embodiments of the present disclosure.

FIG. 6 is a block diagram illustrating dynamic attributers for a system for determining apportionments for agricultural products to growing locations, such as the system illustrated in FIG. 1, in accordance with example embodiments of the present disclosure.

FIG. 7 is a diagrammatic illustration of a first set of growing locations and a second set of growing locations for a system for determining apportionments for agricultural products to the first and second sets of growing locations, such as the system illustrated in FIG. 1, where the first and second sets of growing locations are different in accordance with example embodiments of the present disclosure.

FIG. 8 is a diagrammatic illustration of a first set of growing locations and a second set of growing locations for a system for determining apportionments for agricultural products to the first and second sets of growing locations, such as the system illustrated in FIG. 1, where the first and second sets of growing locations have some locations in common in accordance with example embodiments of the present disclosure.

FIG. 9 is a diagrammatic illustration of a first set of growing locations and a second set of growing locations for a system for determining apportionments for agricultural products to the first and second sets of growing locations, such as the system illustrated in FIG. 1, where the first and second sets of growing locations have some locations in common in accordance with example embodiments of the present disclosure.

FIG. 10 is a diagrammatic illustration of a first set of growing locations and a second set of growing locations for a system for determining apportionments for agricultural products to the first and second sets of growing locations, such as the system illustrated in FIG. 1, where the first and second sets of growing locations have some locations in common in accordance with example embodiments of the present disclosure.

FIG. 11 is a diagrammatic illustration of a first set of growing locations and a second set of growing locations for a system for determining apportionments for agricultural products to the first and second sets of growing locations, such as the system illustrated in FIG. 1, where the first and second sets of growing locations are the same in accordance with example embodiments of the present disclosure.

FIG. 12A is a flow diagram illustrating methods for determining apportionments for agricultural products (e.g., fixed amounts of seed) to one or more growing locations (e.g., agricultural fields) based upon data collected from various sources, such as one or more sensors, in accordance with example embodiments of the present disclosure.

FIG. 12B is a continuation of the flow diagram from FIG. 12A.

FIG. 12C is a continuation of the flow diagram from FIG. 12B.

FIG. 12D is a continuation of the flow diagram from FIG. 12C.

FIG. 12E is a continuation of the flow diagram from FIG. 12D.

### DETAILED DESCRIPTION

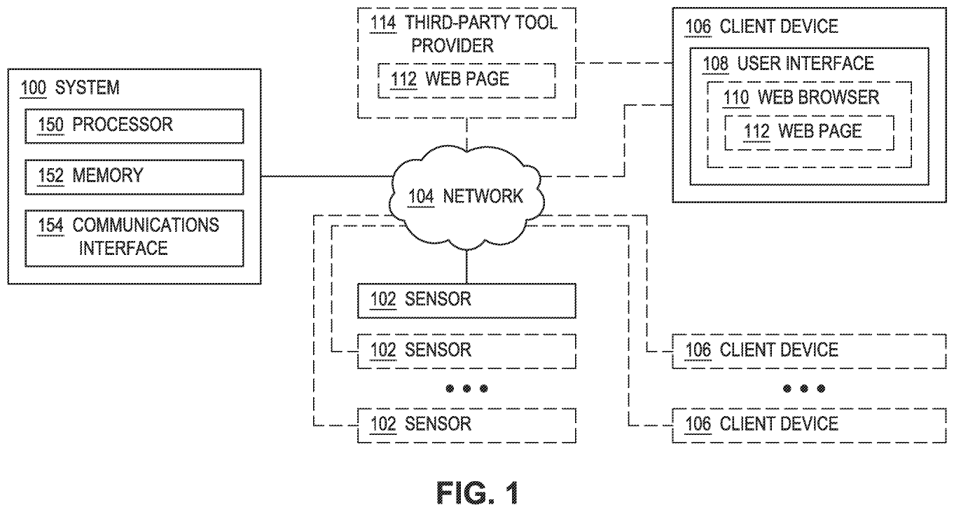

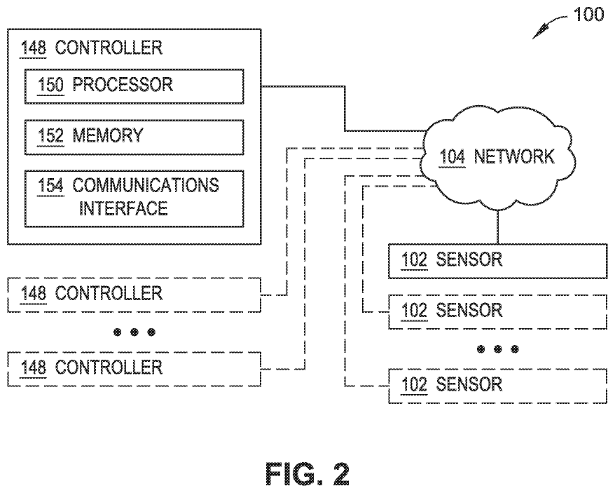

Referring generally to FIGS. 1 through 12E, systems, methods, and apparatus for determining apportionments for agricultural products (e.g., fixed amounts of seed) to one or more growing locations (e.g., agricultural fields) are described in accordance with example embodiments of the present disclosure. The apportionments can be made for a growing season based upon historical growing performances for the selected locations and/or for different or overlapping growing locations. The systems, methods, and apparatus described herein can use various data sources to identify the growing locations and associated apportionments for the agricultural products.

As described herein, intrinsic attributes (e.g., attributes that generally do not change between successive growing seasons) and extrinsic attributes (e.g., attributes that generally change between growing seasons) are remotely collected for two or more growing locations. The intrinsic and extrinsic attributes are collected for a prior (e.g., historic) growing season. In some embodiments, one or more dynamic attributes can also be derived from the intrinsic and/or extrinsic attributes. Life cycle stage timing and field productivity are mechanistically modeled for the first and second growing locations based upon the intrinsic attributes and the extrinsic attributes.

Aggregate commercial desirabilities (e.g., amounts of protein, amounts of oil, amounts of fiber, amounts of profit, etc.) are determined for crop samples grown in the first and second growing locations during the prior growing season, e.g., based upon commercially processing the crop samples. The aggregate commercial desirabilities are then normalized with respect to one another to establish commercial desirability indices. A controller is trained to identify a subset of the intrinsic and/or extrinsic attributes (and possibly the dynamic attributes) for the first and second growing locations that are correlated with the commercial desirability indices. In some embodiments, the controller can be trained using one or more machine learning techniques, such as deep learning.

Intrinsic attributes and extrinsic attributes are remotely collected for two or more growing locations for a subsequent (e.g., upcoming, current) growing season. These third and fourth growing locations may be different from the first and second growing locations, and one or more of them may be the same growing locations. The trained controller predicts commercial desirability indices for the first and fourth growing locations specific to the subsequent growing season based upon the subset of identified intrinsic, extrinsic, and/or dynamic attributes. An apportionment is determined for a fixed amount of agricultural products (e.g., seed) to growing locations that may or may not include the third and fourth growing locations based upon the predicted commercial desirability indices.

In this manner, growing locations such as agricultural fields can be identified and targeted for placing varieties of seeds and other agricultural products to produce seeds and/or grain with desired attributes (e.g., high protein). Model predictions can be used to guide production contracting. For example, rank-listed fields and regions can be targeted for agricultural production. In other instances, field and regions most likely to consistently produce crops with desired attributes, and/or to provide desired transit distances to transfer/production facilities and/or profit margins can be identified. Risk of under or overproduction during a particular growing season may also be evaluated using the systems, techniques, and apparatus described herein.

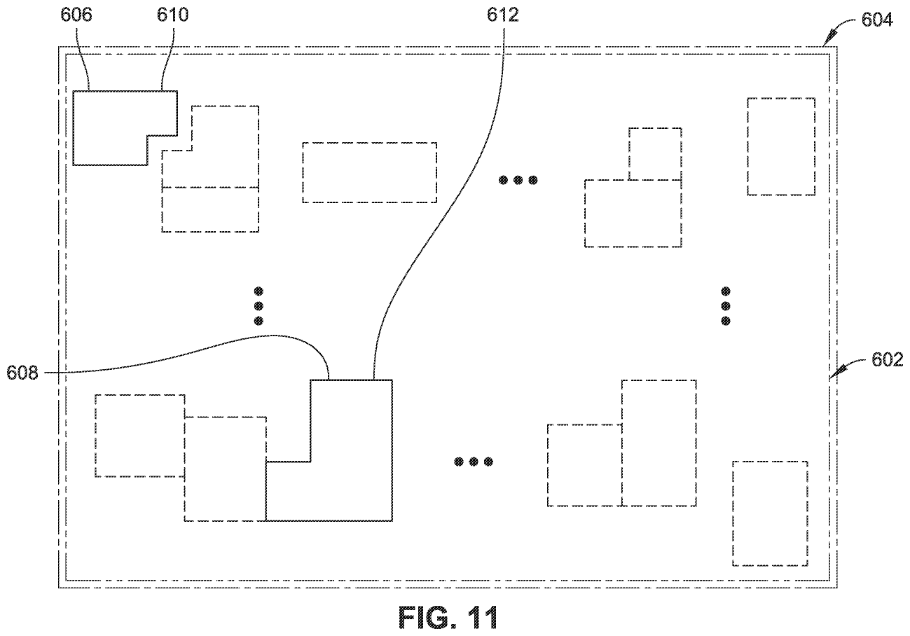

Referring now to FIGS. 1 and 11, systems 100 are described in accordance with example embodiments of the present disclosure. A system 100 can be used to determine apportionments for agricultural products (e.g., fixed amounts of seed) to one or more growing locations (e.g., agricultural fields) based upon data collected from various sources, such as one or more sensors 102. While agricultural fields are described as examples of growing locations with some specificity herein, for the purposes of the present disclosure, the term “growing location” shall be understood to mean any space where agricultural products are or have been grown, as well as spaces that may be cultivated for the growth of agricultural products. For instance, other examples of growing locations include, but are not necessarily limited to: greenhouses, hothouses, growth chambers, screen tents, and so forth. In some embodiments a growing location may be defined by one or more legal boundaries, such as property lines or lot lines. In some embodiments, a growing location may be arbitrarily defined. For example, multiple growing locations may be specified within a single agricultural field, e.g., at a sub-field scale. In some embodiments multiple agricultural fields may be grouped into a single growing location, e.g., in an enterprise level operation, where multiple agricultural fields in different states or regions may be grouped together. A system 100 is configured to connect to a network 104 and communicate with the sensors 102. Examples of sensors 102 include, but are not necessarily limited to: an electronic field log, a near-infrared spectroscopy (NIR) instrument, an in-field weather station, a soil moisture probe, a spectral sensor, a light detection and ranging (LIDAR) sensor, a climate sensor, a crop history sensor, a soil history sensor, a land parcel ownership sensor, and so forth.

The system 100 can also be configured to provide one or more client devices 106 with a user interface 108 for receiving and interacting with information from the system 100, such as the apportionments. In some embodiments, the apportionments can be provided in the form of a list or table of results. A client device 106 can be an information handling system device, including, but not necessarily limited to: a mobile computing device (e.g., a hand-held portable computer, a personal digital assistant (PDA), a laptop computer, a netbook computer, a tablet computer, and so forth), a mobile telephone device (e.g., a cellular telephone, a smartphone), a device that includes functionalities associated with smartphones and tablet computers (e.g., a phablet), a portable game device, a portable media player device, a multimedia device, an e-book reader device (eReader), a smart television (TV) device, a surface computing device (e.g., a table top computer), a personal computer (PC) device, and so forth. However, the apportionments are not necessarily provided to a client device 106. The apportionments are also not necessarily provided via a user interface 108. In some embodiments, apportionments can be provided at the system level, e.g., in the form of a list of results, a table of results, and/or another type of electronic file, which may be provided to another system outside of the system 100, to other software executing within a system 100, and so forth.

In some embodiments, a system 100 provides on demand software, e.g., in the manner of software as a service (SaaS) distributed to a client device 106 via the network 104 (e.g., the Internet). For example, a system 100 hosts agricultural product apportioning software and associated data in the cloud. The software is accessed by the client device 106 with a thin client (e.g., via a web browser 110). A user interfaces with the software (e.g., a web page 112) provided by the system 100 via the user interface 108 (e.g., using web browser 110). In embodiments of the disclosure, the system 100 communicates with a client device 106 using an application protocol, such as hypertext transfer protocol (HTTP). In some embodiments, the system 100 provides a client device 106 with a user interface 108 accessed using a web browser 110 and displayed on a monitor and/or a mobile device. Web browser form input can be provided using a hypertext markup language (HTML) and/or extensible HTML (XHTML) format, and can provide navigation to other web pages (e.g., via hypertext links). The web browser 110 can also use other resources such as style sheets, scripts, images, and so forth.

In other embodiments, content is served to a client device 106 using another application protocol. For instance, a third-party tool provider 114 (e.g., a tool provider not operated and/or maintained by a system 100) can include content from a system 100 (e.g., embedded in a web page 112 provided by the third-party tool provider 114). It should be noted that a thin client configuration for the client device 106 is provided by way of example only and is not meant to limit the present disclosure. In other embodiments, the client device 106 is implemented as a thicker (e.g., fat, heavy, rich) client. For example, the client device 106 provides rich functionality independently of the system 100. In some embodiments, one or more cryptographic protocols are used to transmit information between a system 100 and a client device 106 and/or a third-party tool provider 114. Examples of such cryptographic protocols include, but are not necessarily limited to: a transport layer security (TLS) protocol, a secure sockets layer (SSL) protocol, and so forth. For instance, communications between a system 100 and a client device 106 can use HTTP secure (HTTPS) protocol, where HTTP protocol is layered on SSL and/or TLS protocol.

Techniques in accordance with the present disclosure can be used to implement cloud-based systems. For the purposes of the present disclosure, the terms cloud-based and cloud computing are used to refer to a variety of computing concepts, generally involving a large number of computers connected through a real-time communication network, such as the Internet. However, cloud computing is provided by way of example and is not meant to limit the present disclosure. The techniques described herein can be used in various computing environments and architectures, including, but not necessarily limited to: client-server architectures where distributed applications are implemented by service providers (servers) and service requesters (clients), peer-to-peer architectures where participants are both suppliers and consumers of resources, and so forth.

A system 100, including some or all of its components, can operate under computer control. For example, a processor 150 can be included with or in a system 100 to control the components and functions of systems 100 described herein using software, firmware, hardware (e.g., fixed logic circuitry), manual processing, or a combination thereof. The terms “controller,” “functionality,” “service,” and “logic” as used herein generally represent software, firmware, hardware, or a combination of software, firmware, or hardware in conjunction with controlling the systems 100. In the case of a software implementation, the module, functionality, or logic represents program code that performs specified tasks when executed on a processor (e.g., central processing unit (CPU) or CPUs). The program code can be stored in one or more computer-readable memory devices (e.g., internal memory and/or one or more tangible media), and so on. The structures, functions, approaches, and techniques described herein can be implemented on a variety of commercial computing platforms having a variety of processors.

The system 100 can include one or more controllers 148. A controller 148 can include a processor 150, a memory 152, and a communications interface 154. The processor 150 provides processing functionality for the controller 148 and can include any number of processors, micro-controllers, or other processing systems, and resident or external memory for storing data and other information accessed or generated by the controller 148. The processor 150 can execute one or more software programs that implement techniques described herein. The processor 150 is not limited by the materials from which it is formed or the processing mechanisms employed therein and, as such, can be implemented via semiconductor(s) and/or transistors (e.g., using electronic integrated circuit (IC) components), and so forth.

The memory 152 is an example of tangible, computer-readable storage medium that provides storage functionality to store various data associated with operation of the controller 148, such as software programs and/or code segments, or other data to instruct the processor 150, and possibly other components of the controller 148, to perform the functionality described herein. Thus, the memory 152 can store data, such as a program of instructions for operating the system 100 (including its components), and so forth. It should be noted that while a single memory 152 is described, a wide variety of types and combinations of memory (e.g., tangible, non-transitory memory) can be employed. The memory 152 can be integral with the processor 150, can comprise stand-alone memory, or can be a combination of both.

The memory 152 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, hard disk memory, external memory, and so forth. In implementations, the system 100 and/or the memory 152 can include removable integrated circuit card (ICC) memory, such as memory provided by a subscriber identity module (SIM) card, a universal subscriber identity module (USIM) card, a universal integrated circuit card (UICC), and so on.

The communications interface 154 is operatively configured to communicate with components of the system 100. For example, the communications interface 154 can be configured to transmit data for storage in the system 100, retrieve data from storage in the system 100, and so forth. The communications interface 154 is also communicatively coupled with the processor 150 to facilitate data transfer between components of the system 100 and the processor 150 (e.g., for communicating inputs to the processor 150 received from a device communicatively coupled with the controller 148, such as a sensor 102). It should be noted that while the communications interface 154 is described as a component of a controller 148, one or more components of the communications interface 154 can be implemented as external components communicatively coupled to the system 100 via a wired and/or wireless connection. The system 100 can also comprise and/or connect to one or more input/output (I/O) devices (e.g., via the communications interface 154), including, but not necessarily limited to: a display, a mouse, a touchpad, a keyboard, and so on.

The communications interface 154 and/or the processor 150 can be configured to communicate with a variety of different networks, including, but not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to limit the present disclosure. Further, the communications interface 154 can be configured to communicate with a single network or multiple networks across different access points.

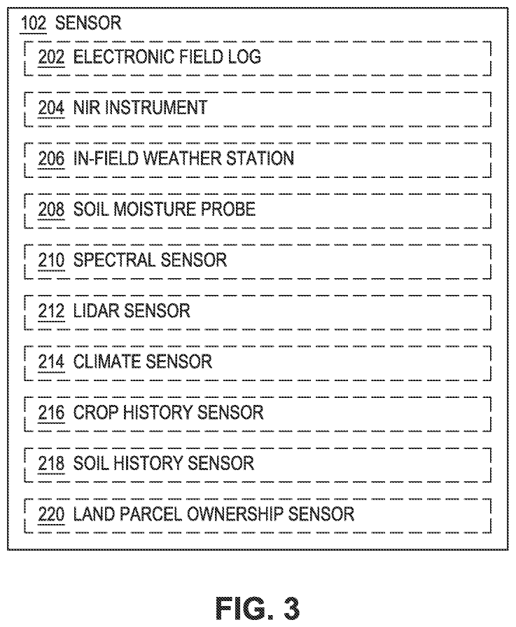

With reference to FIG. 3, a system 100 can be used to determine apportionments for agricultural products (e.g., fixed amounts of seed) to one or more growing locations (e.g., agricultural fields) based upon data collected from various sensors 102. Sensors 102 can include sources of public and/or private information about various growing locations. An example of private information collected from a sensor 102 is an electronic field log 202 (e.g., field notes). In some embodiments, an electronic field log 202 can include information compiled by in-field data collection, such as crop protein and composition characteristics, information about treatments, such as fertilizers and/or microbial treatments applied to an agricultural field, and so forth. In some embodiments, a sensor 102 can be a near-infrared spectroscopy (NIR) instrument 204 used to determine NIR-based composition characteristics of a crop. In some embodiments, a sensor 102 can be an in-field weather station 206. In some embodiments, a sensor 102 can be a soil moisture probe 208. It should be noted that electronic field logs, NIR instruments, in-field weather stations, and soil moisture probes are provided by way of example and are not meant to limit the present disclosure. In embodiments, other sources of public and/or private information may be used to collect information about various growing locations, including, but not necessarily limited to: crop yield monitors, sensors that evaluate the amount of grain harvested from a growing location, and so forth.

Information collected from a sensor 102 may also include publicly available information. In some embodiments, a sensor 102 may be a spectral sensor 210. For example, a system 100 can be furnished with amassed spectral data from one or more moderate resolution imaging spectroradiometer (MODIS) sensors, e.g., from a sensor that captures data in spectral bands ranging in wavelength from about four-tenths of a micrometer (0.4 μm) to about fourteen and four-tenths of a micrometer (14.4 μm) at varying spatial resolutions (e.g., two (2) bands at two hundred and fifty meters (250 m), five (5) bands at five hundred meters (500 m), twenty-nine (29) bands at one kilometer (1 km), and so forth). In another example, a system 100 can be furnished with amassed spectral data from a Landsat satellite system, such as operational land imager (OLI) and thermal infrared sensor (TIRS) instrument data.

In a further example, the system 100 can be furnished with data from a light detection and ranging (LIDAR) sensor 212, such as a satellite-based LIDAR sensor. In some embodiments, a sensor 102 may be a climate sensor 214, such as a United States National Center for Atmospheric Research (NCAR) sensor, a United States National Oceanic and Atmospheric Administration (NOAA) sensor, and so forth. In some embodiments, connection to a sensor 102 can be furnished by a software intermediary, such as an application programming interface (API). For example, in some embodiments, a sensor 102 can be a crop history sensor 216, accessed via a querying system, such as the United States Department of Agriculture (USDA) national agricultural statistics service (NASS) web-based querying system. In some embodiments, a sensor 102 can be a soil history sensor 218, accessed via a querying system, such as the USDA soil survey geographic database (SSURGO) querying system. Data accessible via the soil history sensor 218 can include historical information about soils collected and/or assessed by surveys, such as the United States National Cooperative Soil survey. In another example, a soil history sensor 218 furnishes access to global soil profile information and covariate data to model the spatial distribution of soil properties across the globe.

In some embodiments, a sensor 102 can be a land parcel ownership sensor 220, accessed via a querying system, such as through an API. Data accessible via the land parcel ownership sensor 220 can include property ownership information such as parcel boundaries (e.g., agricultural field boundaries), national property data, and so forth. In some embodiments, a controller 148 can be operatively configured to receive data from one or more sensors 102 and/or to retrieve data from the memory 152, and to derive additional information from various combinations of the data. For example, spectral data from various spectral sensors 210, such as MODIS and Landsat data, can be combined as described in the following publication: Filgueiras R, Mantovani E C, Fernandes-Filho E I, Cunha FFd, Althoff D, Dias S H B. Fusion of MODIS and Landsat-Like Images for Daily High Spatial Resolution NDVI. Remote Sensing. 2020; 12(8):1297. https://doi.org/10.3390/rs12081297, which is herein incorporated by reference in its entirety. In some embodiments, data received and/or retrieved by a controller 148 can be used to derive and/or identify agricultural field boundaries for geographic areas. For example, geographic raster or grid information can be used to identify contiguous areas that are managed similarly, and/or have similar crop histories, e.g., based upon crop varieties.

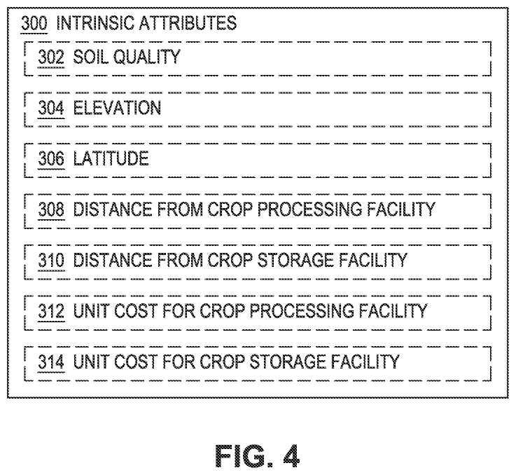

Referring now to FIG. 4, a sensor 102 can be used to remotely collect intrinsic attributes 300 for a particular growing location (e.g., for an agricultural field). For the purposes of the present disclosure, the term “intrinsic attributes” shall be understood to refer to attributes that are generally unchanging or at least substantially the same between successive growing seasons, such as parcel boundaries. However, intrinsic attributes may change at various times, and the system 100 may account for these changes. For example, when a parcel of land is subdivided, legacy data may be updated accordingly to account for new parcel boundaries.

As described herein, intrinsic attributes 300 for a growing location can include, but are not necessarily limited to: soil quality 302, elevation 304, latitude 306, and so forth. For example, soil quality 302 information from a soil history sensor 218 accessed via a querying system, such as the USDA SSURGO querying system, includes historical information about soils collected and/or assessed by surveys. Another example of an intrinsic attribute 300 for a growing location is a distance of a growing location from a crop processing facility 308. A further example of an intrinsic attribute 300 for a growing location is a distance of a growing location from a crop storage facility 310. Another example of an intrinsic attribute 300 for a growing location is a unit cost for a crop processing facility 308. A further example of an intrinsic attribute 300 for a growing location is a unit cost for a crop storage facility 310.

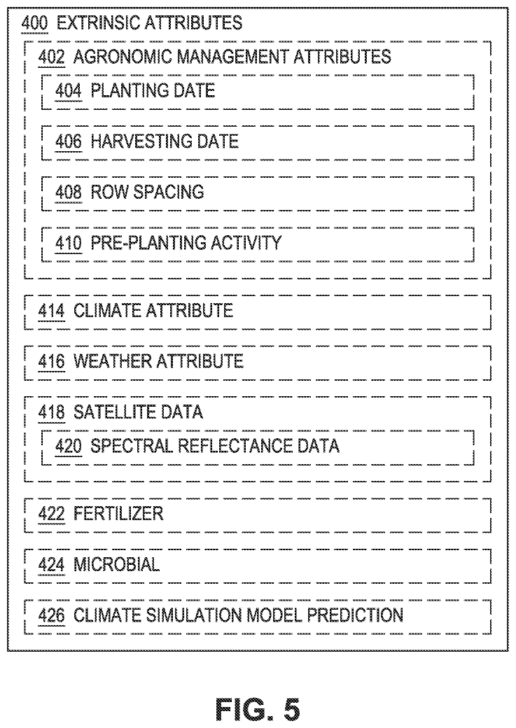

With reference to FIG. 5, a sensor 102 can be used to remotely collect extrinsic attributes 400 for a particular growing location (e.g., for an agricultural field). For the purposes of the present disclosure, the term “extrinsic attributes” shall be understood to refer to attributes that generally change or are at least substantially different between successive growing seasons, such as weather. However, extrinsic attributes may be at least substantially similar between successive growing seasons in some instances, and the system 100 may account for these similarities. For example, when weather data is lacking for a particular growing season, legacy data may be used to supply presumptive weather conditions for a growing location.

As described herein, extrinsic attributes 400 for a growing location can include, but are not necessarily limited to: one or more agronomic management attributes 402, such as a planting date 404, a harvesting date 406, a row spacing 408, a pre-planting activity 410, and so forth. For example, row spacing 408 information from an electronic field log 202 may be indicative of a fifteen inch (15″) spacing between rows of soybean crops planted in an agricultural field. Another example of an extrinsic attribute 400 for a growing location is a climate attribute 414. A further example of an extrinsic attribute 400 for a growing location is a weather attribute 416. Another example of an extrinsic attribute 400 for a growing location is data 418 collected by satellites, such as spectral reflectance data 420. A further example of an extrinsic attribute 400 for a growing location is a fertilizer 422 application. Another example of an extrinsic attribute 400 for a growing location is a microbial 424 application. A further example of an extrinsic attribute 400 for a growing location is a climate simulation model prediction 426.

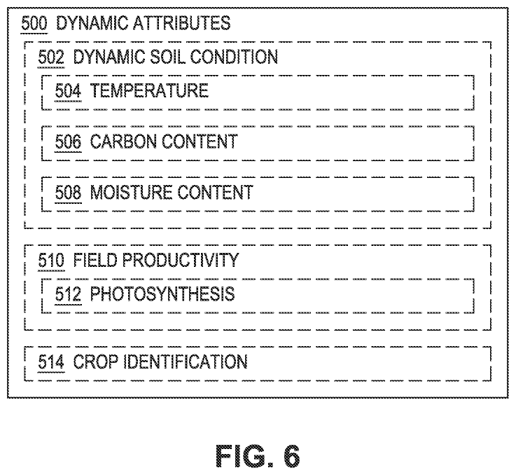

Referring now to FIG. 6, a controller 148 can be configured to derive one or more dynamic attributes 500 from one or more attributes selected from the intrinsic attributes 300 and/or the extrinsic attributes 400. For example, a dynamic soil condition 502, such as temperature 504, carbon content 506, moisture content 508, and so forth can be derived from data from a spectral sensor 210 (FIG. 3). Another example of a dynamic attribute 500 derived from one or more attributes selected from the intrinsic attributes 300 and/or the extrinsic attributes 400 is a field productivity 510, such as photosynthesis 512. A further example of a dynamic attribute 500 derived from one or more attributes selected from the intrinsic attributes 300 and/or the extrinsic attributes 400 is a crop identification 514. In embodiments of the disclosure, dynamic soil conditions 502, field productivities 510, crop identifications 514, and so forth can be derived from spectral reflectance data, such as the spectral reflectance data 420 and/or other satellite data 418 (FIG. 5).

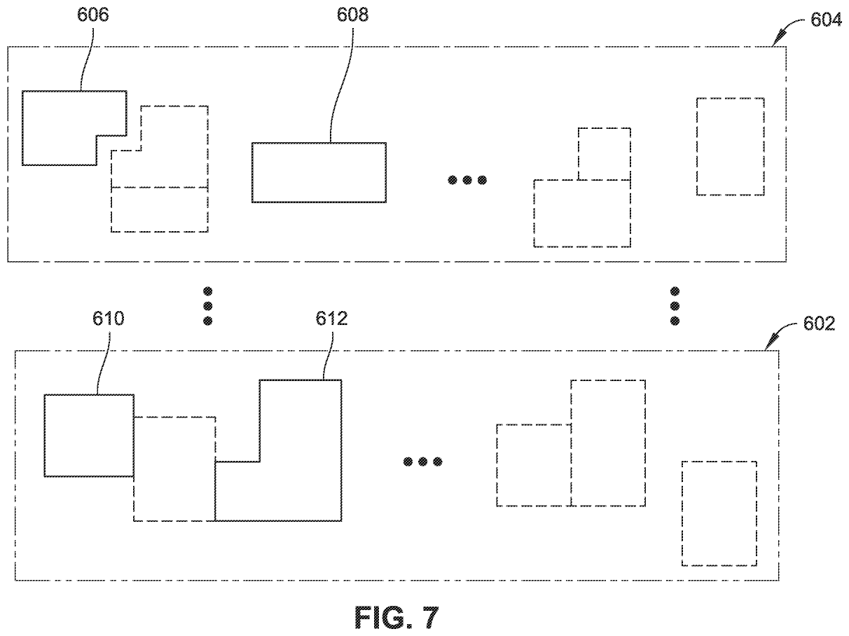

With reference to FIGS. 7 through 11, the systems, techniques, and apparatus of the present disclosure can be used to determine apportionments for agricultural products (e.g., fixed amounts of seed) to a first set of growing locations 602 for a first growing season based upon prior growing performances of at least one of the first set of growing locations 602 or a second set of growing locations 604 different from or overlapping with the first set of growing locations 602. In some embodiments, the first set of growing locations 602 and the second set of growing locations 604 may include different growing locations (FIGS. 7 through 10). For example, a first set of test locations may be sampled to establish protein and/or other compositional characteristic baselines, e.g., to collect training data for a machine learning model. In some embodiments, the first set of growing locations 602 and the second set of growing locations 604 may be the same growing locations (FIG. 11). In some embodiments, there are no presumptive or a priori selection criteria applied when selecting a second set of growing locations 604. It should be noted that the systems, techniques, and apparatus of the present disclosure can be used to identify apportionments for agricultural products that may be counterintuitive or unexpected, and the ability to determine the apportionments without a priori selection allows candidate growing locations to be included that may otherwise not be considered. An example of such an unexpected apportionment is the identification of growing locations having topographical variations (e.g., multiple slopes) that may not be desirable from a yield standpoint but may be unexpectedly desirable when a higher percentage of protein is desired.

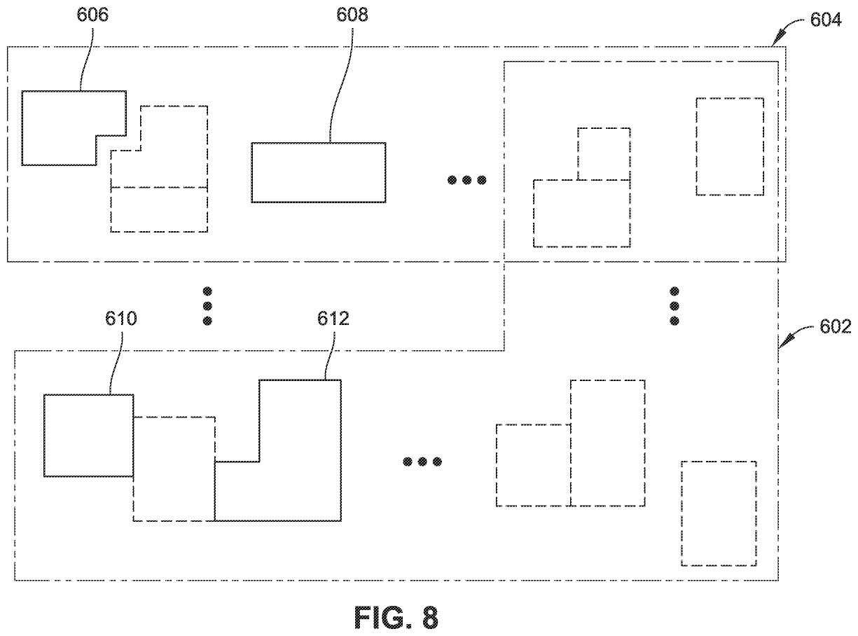

As described, the second set of growing locations 604 may be similar to the first set of growing locations 602, e.g., having one or more attributes similar or identical to attributes of the first set of growing locations 602, including, but not necessarily limited to: soil quality, elevation, latitude, distance from a crop processing or storage facility, unit cost for a crop processing or storage facility, and so forth. In some embodiments, the second set of growing locations 604 overlaps with the first set of growing locations 602, e.g., sharing land with the first set of growing locations 602, as described with reference to FIGS. 8 through 10. In some embodiments, the second set of growing locations 604 may be substantially different from the first set of growing locations 602, e.g., having one or more attributes substantially different from the attributes of the first set of growing locations 602.

Referring now to FIG. 7, in some embodiments, the first set of growing locations 602 and the second set of growing locations 604 may be different growing locations, e.g., where the second set of growing locations 604 includes at least a first growing location 606 and a second growing location 608, for which intrinsic attributes 300 and extrinsic attributes 400 are collected for a second growing season prior to a first growing season, and where the first set of growing locations 602 includes at least a third growing location 610 and a fourth growing location 612, for which intrinsic attributes 300 and extrinsic attributes 400 are collected for a first growing season subsequent to the second growing season, and for which apportionments for agricultural products (e.g., fixed amounts of seed) are determined for the first growing season.

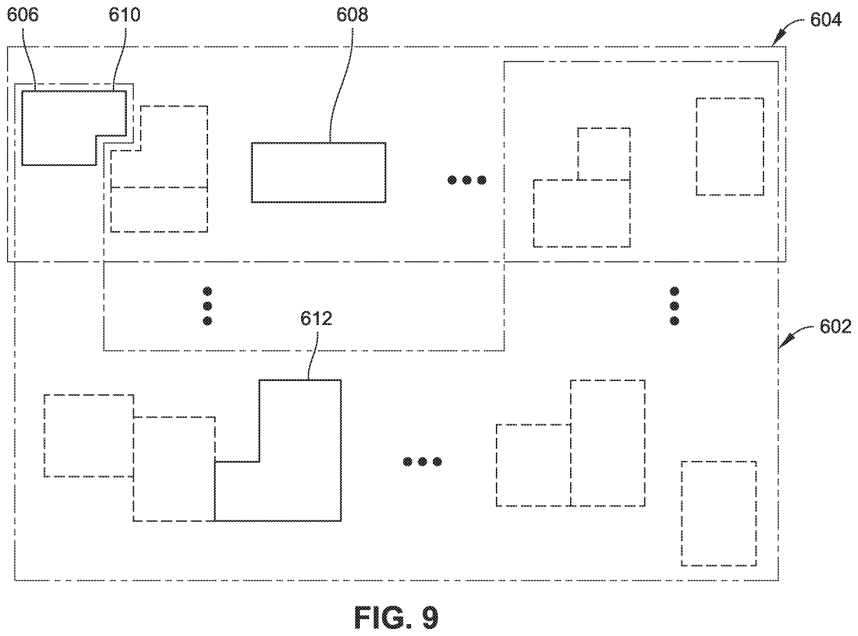

With reference to FIG. 8, in some embodiments, the first set of growing locations 602 and the second set of growing locations 604 may share some growing locations, e.g., where the second set of growing locations 604 includes at least a first growing location 606 and a second growing location 608, and where the first set of growing locations 602 includes at least a different third growing location 610 and a different fourth growing location 612. Referring now to FIG. 9, the first set of growing locations 602 and the second set of growing locations 604 may share some growing locations, where the second set of growing locations 604 includes at least a first growing location 606 and a second growing location 608, and where the first set of growing locations 602 includes at least a third growing location 610 the same as the first growing location 606 and a different fourth growing location 612.

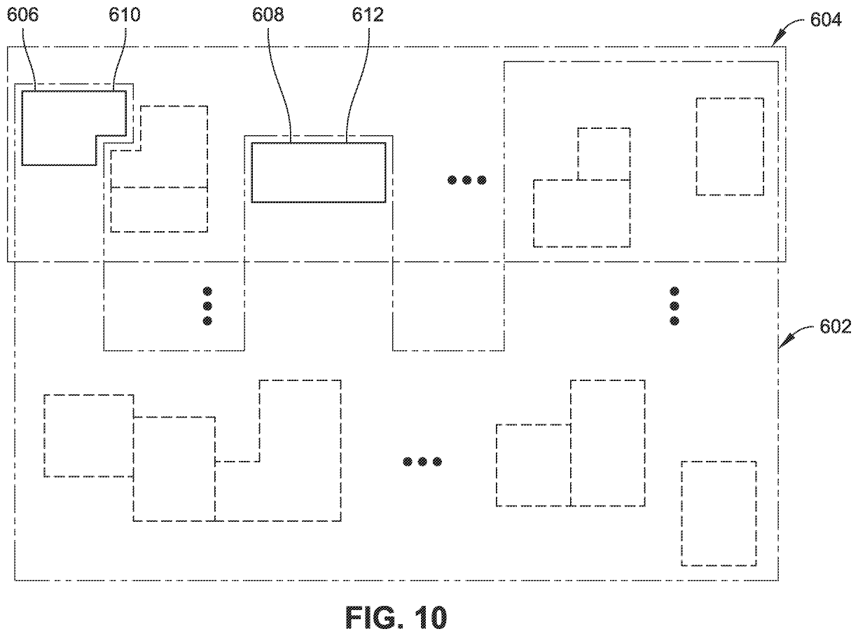

With reference to FIG. 10, in some embodiments, the first set of growing locations 602 and the second set of growing locations 604 may share some growing locations, e.g., where the second set of growing locations 604 includes at least a first growing location 606 and a second growing location 608, and where the first set of growing locations 602 includes at least a third growing location 610 the same as the first growing location 606 and a fourth growing location 612 the same as the second growing location 608. Referring now to FIG. 11, the first set of growing locations 602 and the second set of growing locations 604 may be the same growing locations, where the second set of growing locations 604 includes at least a first growing location 606 and a second growing location 608, and where the first set of growing locations 602 includes at least a third growing location 610 the same as the first growing location 606 and a fourth growing location 612 the same as the second growing location 608.

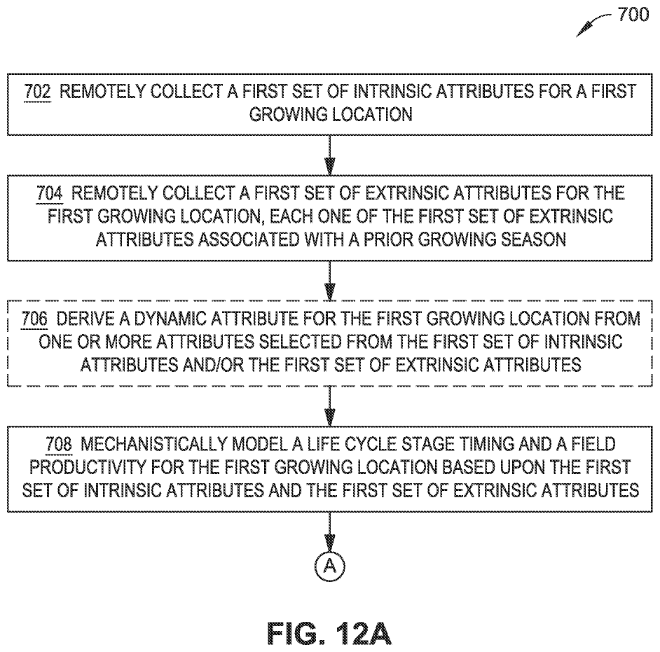

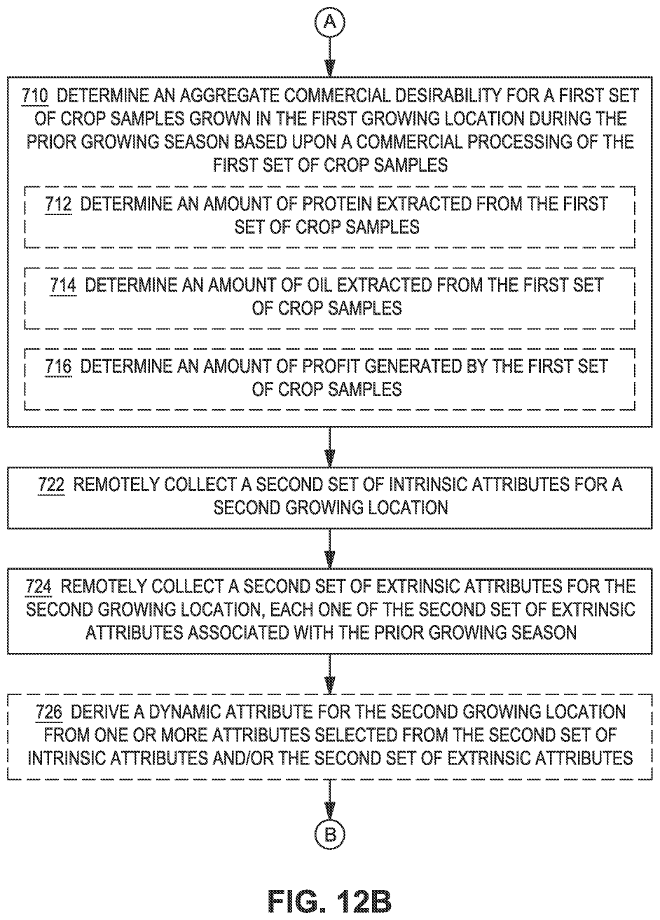

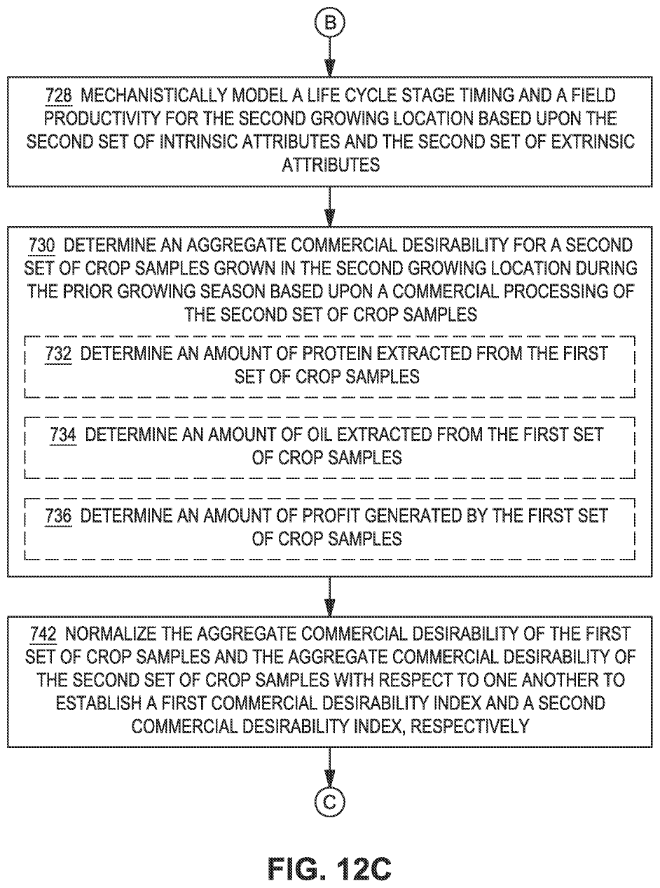

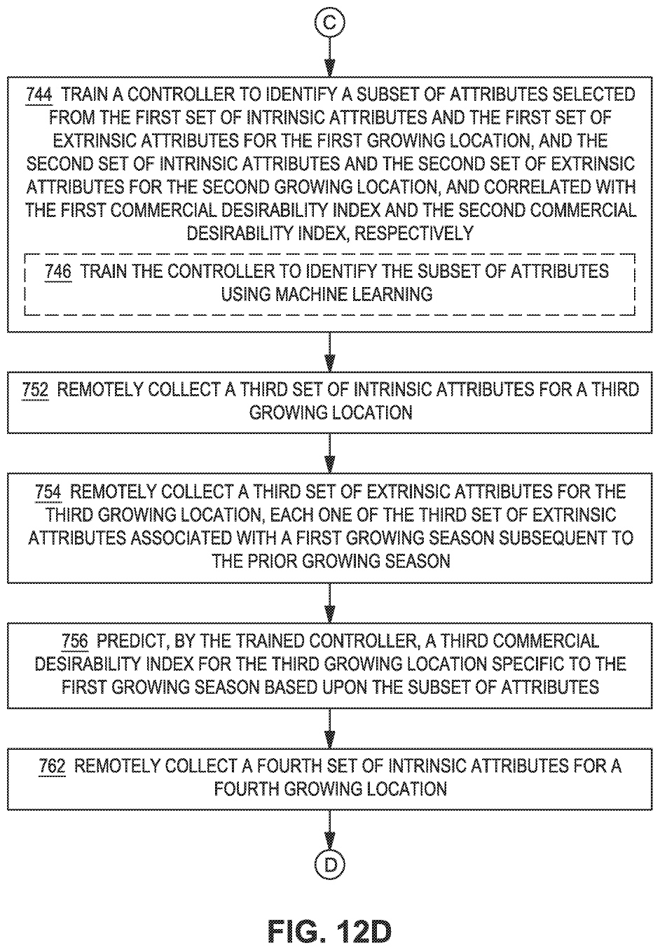

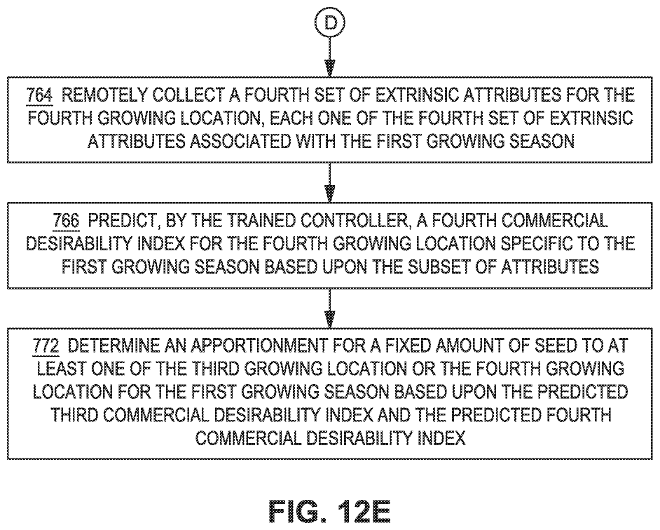

The following discussion describes example techniques for determining apportionments for agricultural products (e.g., fixed amounts of seed) to one or more growing locations (e.g., agricultural fields). FIGS. 12A through 12E depict a process 700, in an example implementation, for determining an apportionment for a fixed amount of agricultural products (e.g., a fixed amount of seed) to a first set of growing locations for a first growing season based upon growing performances of at least one of the first set of growing locations or a second set of growing locations different from or overlapping with the first set of growing locations, such as the first set of growing locations 602 and the second set of growing locations 604 illustrated in FIGS. 7 through 11 and described above.

In the process 700 illustrated, a first set of intrinsic attributes is remotely collected for a first growing location (Block 702). For example, with reference to FIGS. 1 through 11, a controller 148 is furnished with information about a first growing location 606 from ones or more sensors 102, including, but not necessarily limited to: electronic field log data, near-infrared spectroscopy (NIR) instrument data, in-field weather station data, soil moisture probe data, spectral sensor data, light detection and ranging (LIDAR) sensor data, climate sensor data, crop history sensor data, soil history sensor data, land parcel ownership sensor data, and so forth. An intrinsic attribute from a sensor 102 can include one or more soil quality measurements, elevation measurements, latitude measurements, distances of a growing location from a crop processing facility, distances of a growing location from a crop storage facility, unit costs for a crop processing facility, unit costs for a crop storage facility, and so forth.

A first set of extrinsic attributes is remotely collected for the first growing location, where each one of the first set of extrinsic attributes is associated with a second growing season prior to the first growing season (Block 704). For instance, with continuing reference to FIGS. 1 through 11, a controller 148 is furnished with information about the first growing location 606 from one or more sensors 102, including, but not necessarily limited to: electronic field log data, near-infrared spectroscopy (NIR) instrument data, in-field weather station data, soil moisture probe data, spectral sensor data, light detection and ranging (LIDAR) sensor data, climate sensor data, crop history sensor data, soil history sensor data, land parcel ownership sensor data, and so forth. An extrinsic attribute from a sensor 102 can include one or more agronomic management attributes (e.g., planting dates, harvesting dates, row spacings, pre-planting activities), climate attributes, weather attributes, satellite data (e.g., spectral reflectance data), fertilizer application data, microbial application data, climate simulation model predictions, and so forth.

In some embodiments, one or more dynamic attributes are derived for the first growing location from one or more attributes selected from the first set of intrinsic attributes and/or the first set of extrinsic attributes (Block 706). For example, with reference to FIGS. 1 through 11, a controller 148 derives a dynamic soil condition 502, a field productivity 510, and/or a crop identification 514 from one or more attributes selected from the intrinsic attributes 300 and/or the extrinsic attributes 400 associated with a first growing location 606, such as the spectral reflectance data 420 and/or other satellite data 418. In another example, spectral data from various spectral sensors 210, such as MODIS and Landsat data, can be combined to determine crop density on the first growing location 606, e.g., by determining a normalized difference vegetation index (NDVI).

A life cycle stage timing and a field productivity are modeled mechanistically, e.g., with one or more process-based approaches, for the first growing location based upon the first set of intrinsic attributes and the first set of extrinsic attributes (Block 708). For the purposes of the present disclosure, terms such as “mechanistic” and “mechanistically modeled” shall be understood to refer to temporally shifting, rearranging, compressing, and/or extending data to account for timing variations in the development/life cycles of agricultural products (e.g., plants) in the field. For example, dates determined by a mechanistic model may be used to label features in the model, such as the intrinsic attributes 300 and the extrinsic attributes 400. As described herein, a mechanistic model may be used to position attributes temporally, e.g., with respect to development of plants in the field. For instance, different fields may have different life cycle schedules. In an example, two neighboring fields are planted two (2) weeks apart. In one field, a second (2nd) growth stage may end on the fifteenth (15th) day of a particular month, whereas in the other field, the second (2nd) growth stage may end on the twenty-ninth (29th) day of the same month. In this example, spectral data collected on the seventeenth (17th) day of that month is labeled as a third (3rd) stage attribute for the first field, whereas spectral data collected on the seventeenth (17th) day of that same month is labeled as a second (2nd) stage attribute for the second field. In this manner, mechanistic modeling is used to align attributes such as NDVI's with specific characteristics of the growing locations.

An aggregate commercial desirability is determined for a first set of crop samples grown in the first growing location based upon a commercial processing of the first set of crop samples, where the first set of crop samples is grown in the first growing location during the prior growing season (Block 710). In some embodiments, the aggregate commercial desirability of the first set of crop samples is determined by an amount of protein extracted from the first set of crop samples (Block 712). In some embodiments, the aggregate commercial desirability of the first set of crop samples is determined by an amount of oil extracted from the first set of crop samples (Block 714). In some embodiments, the aggregate commercial desirability of the first set of crop samples is determined by an amount of profit generated by the first set of crop samples (Block 716). For instance, with continuing reference to FIGS. 1 through 11, a first crop of soybeans is harvested from the first growing location 606, and an amount of protein is extracted from the first crop of soybeans at a crop processing facility. It should be noted that while the amount of protein, amount of oil, and amount of profit are listed herein with some specificity, these traits are provided by way of example and are not meant to limit the present disclosure. In other embodiments, different traits may also be utilized to determine aggregate commercial desirabilities, such as an amount of fiber, and so forth.

A second set of intrinsic attributes is remotely collected for a second growing location (Block 722). For example, with reference to FIGS. 1 through 11, a controller 148 is furnished with information about a second growing location 608 from one or more sensors 102, including, but not necessarily limited to: electronic field log data, near-infrared spectroscopy (NIR) instrument data, in-field weather station data, soil moisture probe data, spectral sensor data, light detection and ranging (LIDAR) sensor data, climate sensor data, crop history sensor data, soil history sensor data, land parcel ownership sensor data, and so forth. An intrinsic attribute from a sensor 102 can include one or more soil quality measurements, elevation measurements, latitude measurements, distances of a growing location from a crop processing facility, distances of a growing location from a crop storage facility, unit costs for a crop processing facility, unit costs for a crop storage facility, and so forth.

A second set of extrinsic attributes is remotely collected for the second growing location, where each one of the second set of extrinsic attributes is associated with the prior growing season (Block 724). For instance, with continuing reference to FIGS. 1 through 11, a controller 148 is furnished with information about the second growing location 608 from one or more sensors 102, including, but not necessarily limited to: electronic field log data, near-infrared spectroscopy (NIR) instrument data, in-field weather station data, soil moisture probe data, spectral sensor data, light detection and ranging (LIDAR) sensor data, climate sensor data, crop history sensor data, soil history sensor data, land parcel ownership sensor data, and so forth. An extrinsic attribute from a sensor 102 can include one or more agronomic management attributes (e.g., planting dates, harvesting dates, row spacings, pre-planting activities), climate attributes, weather attributes, satellite data (e.g., spectral reflectance data), fertilizer application data, microbial application data, climate simulation model predictions, and so forth.

In some embodiments, one or more dynamic attributes are derived for the second growing location from one or more attributes selected from the second set of intrinsic attributes and/or the second set of extrinsic attributes (Block 726). For example, with reference to FIGS. 1 through 11, a controller 148 derives a dynamic soil condition 502, a field productivity 510, and/or a crop identification 514 from one or more attributes selected from the intrinsic attributes 300 and/or the extrinsic attributes 400 associated with a second growing location 608, such as the spectral reflectance data 420 and/or other satellite data 418. In another example, spectral data from various spectral sensors 210, such as MODIS and Landsat data, can be combined to determine crop density on the second growing location 608, e.g., by determining a normalized difference vegetation index (NDVI).

A life cycle stage timing and a field productivity are mechanistically modeled for the second growing location based upon the second set of intrinsic attributes and the second set of extrinsic attributes (Block 728). For example, dates determined by a mechanistic model may be used to label features in the model, such as the intrinsic attributes 300 and the extrinsic attributes 400. As previously described, a mechanistic model may be used to position attributes temporally, e.g., with respect to development of plants in the field. Thus, mechanistic modeling is used to align attributes such as NDVI's with specific characteristics of the growing locations.

An aggregate commercial desirability is determined for a second set of crop samples grown in the second growing location based upon a commercial processing of the second set of crop samples, where the second set of crop samples is grown in the second growing location during the prior growing season (Block 730). In some embodiments, the aggregate commercial desirability of the second set of crop samples is determined by an amount of protein extracted from the second set of crop samples (Block 732). In some embodiments, the aggregate commercial desirability of the second set of crop samples is determined by an amount of oil extracted from the second set of crop samples (Block 734). In some embodiments, the aggregate commercial desirability of the second set of crop samples is determined by an amount of profit generated by the second set of crop samples (Block 736). For instance, with continuing reference to FIGS. 1 through 11, a second crop of soybeans is harvested from the second growing location 608, and an amount of protein is extracted from the second crop of soybeans at a crop processing facility.

The aggregate commercial desirability of the first set of crop samples and the aggregate commercial desirability of the second set of crop samples are normalized with respect to one another to establish a first commercial desirability index and a second commercial desirability index, respectively (Block 742). For example, with reference to FIGS. 1 through 11, after commercially processing soybean crops from the first growing location 606, the protein concentration in the commercial product from the first growing location 606 is about sixty-three percent (63%). In this example, the first commercial desirability index for the soybean crops from the first growing location 606 is “low desirability” because it does not achieve a pre-defined product specification of sixty-five percent (65%) protein concentration. Normalizing the first set of crop samples and the second set of crop samples with respect to one another, after similar commercially processing soybean crops from the second growing location 608, the protein concentration is about seventy percent (70%) in the commercial product from the second growing location 608. In this example, the second commercial desirability index for the soybean crops from the second growing location 608 is “high desirability” because it exceeds the pre-defined product specification of sixty-five percent (65%) protein concentration.

A controller is trained to identify a subset of attributes selected from the first set of intrinsic attributes and the first set of extrinsic attributes for the first growing location, and the second set of intrinsic attributes and the second set of extrinsic attributes for the second growing location, and correlated with the first commercial desirability index and the second commercial desirability index, respectively (Block 744). In some embodiments, the controller can be trained to identify the subset of attributes using machine learning (Block 746). For instance, with continuing reference to FIGS. 1 through 11, the controller 148 can be trained, via a machine learning technique, such as deep learning, to identify a subset of attributes selected from the intrinsic attributes 300 and/or the extrinsic attributes 400 for the first growing location 606, and/or the intrinsic attributes 300 and/or the extrinsic attributes 400 for the second growing location 608.

In some embodiments, the controller 148 can be trained to identify a subset of attributes selected from the intrinsic attributes 300, the extrinsic attributes 400, and/or the dynamic attributes 500 using one or more machine learning algorithms that improve through experience and use of data from the sensors 102. For example, the controller 148 models the environment of the second set of growing locations 604 based on sensor data and is then able to make predictions about other growing locations, such as the first set of growing locations 602. In some embodiments, the controller 148 identifies the subset of attributes using one or more artificial neural networks.

In some embodiments, the controller 148 can use an elastic net regularized regression method to identify the subset of attributes. For example, information collected from the sensors 102 about the second set of growing locations 604 may have strong spatial and temporal variable correlation. However, elastic net regression is provided by way of example and is not meant to limit the present disclosure. In other embodiments, different regression methods may be used for attribute identification.

As described herein, the controller 148 may use one or more machine learning models in training. In some embodiments, a machine learning pipeline can be implemented as an auto-scaling cluster, where model development, algorithm selection, and evaluation are conducted within the machine learning environment. For example, during a model fitting, distributed random forest (DRF) classification and regression (e.g., random forest and extremely-randomized trees), generalized linear models (GLM), extreme gradient boosting (XGBoost), gradient boosting machine (GBM), and fuzzy neural net (FNN) may be evaluated by the controller 148. Algorithm selection can then be based on an area under the precision recall curve. It should be noted that algorithm selection based on an area under a precision recall curve is provided by way of example and is not meant to limit the present disclosure. In other embodiments, algorithm selection may be based on one or more other algorithm selection techniques, including, but not necessarily limited to: root mean square error (RMSE) selection, mean square error (MSE) selection, F1 selection, precision selection, recall selection, accuracy selection, and so forth. Additionally, one or more other model evaluation metrics may be used to evaluate efficacy, including, but not necessarily limited to: R-squared (R²), beta, Akaike's information criterion (AIC), Quasi information criterion (QIC), Bayesian information criterion (BIC), and so forth.

Once one or more top-ranked algorithms are identified and fitted using a global dataset, within that market class, production models can be saved by the system 100. In some embodiments, the models can be saved as model object optimized (MOJO) deployment ready artifacts. However, the MOJO model object format is provided by way of example and is not meant to limit the present disclosure. In other embodiments, a model can be saved in one or more other file formats. In some embodiments, further testing can be performed using spatio-temporal data segregation rules (e.g., as described above) to develop F1 (weighted average of precision and recall), accuracy, precision, and/or recall measures, which can be evaluated prior to model deployment. It should be noted that while certain machine learning and deep learning algorithms and regression techniques have been described with some specificity herein, these algorithms and techniques are provided by way of example and are not meant to limit the present disclosure. In some embodiments, other machine learning and regression techniques may be used with the systems, techniques, and apparatus of the present disclosure.

A third set of intrinsic attributes is remotely collected for a third growing location (Block 752). For example, with reference to FIGS. 1 through 11, a controller 148 is furnished with information about a third growing location 610 from one or more sensors 102 (e.g., as previously described). A third set of extrinsic attributes is remotely collected for the third growing location, where each one of the third set of extrinsic attributes is associated with the first growing season (Block 754). For instance, with continuing reference to FIGS. 1 through 11, a controller 148 is furnished with information about the third growing location 610 from one or more sensors 102 (e.g., as previously described). The trained controller predicts a third commercial desirability index for the third growing location specific to the first growing season based upon the subset of attributes (Block 756). For example, with reference to FIGS. 1 through 11, the controller 148 predicts a third commercial desirability index (e.g., kilograms of protein per bushel of soybean crops) for the third growing location 610.

A fourth set of intrinsic attributes is remotely collected for a fourth growing location (Block 762). For example, with reference to FIGS. 1 through 11, a controller 148 is furnished with information about a fourth growing location 612 from one or more sensors 102 (e.g., as previously described). A fourth set of extrinsic attributes is remotely collected for the fourth growing location, where each one of the fourth set of extrinsic attributes is associated with the first growing season (Block 764). For instance, with continuing reference to FIGS. 1 through 11, a controller 148 is furnished with information about the fourth growing location 612 from one or more sensors 102 (e.g., as previously described). The trained controller predicts a fourth commercial desirability index for the fourth growing location specific to the first growing season based upon the subset of attributes (Block 766). For example, with reference to FIGS. 1 through 11, the controller 148 predicts a fourth commercial desirability index (e.g., kilograms of protein per bushel of soybean crops) for the fourth growing location 612.

An apportionment for a fixed amount of seed to at least one of the third growing location or the fourth growing location for the first growing season based upon the predicted third commercial desirability index and the predicted fourth commercial desirability index is determined (Block 772). For instance, with continuing reference to FIGS. 1 through 11, after the controller 148 determines a commercial desirability index for soybean crops for the third growing location 610 of “high desirability” (e.g., sixty-nine percent (69%) protein concentration) and a commercial desirability index for soybean crops for the fourth growing location 612 of “low desirability” (e.g., sixty-three percent (63%) protein concentration), the controller 148 apportions soybean seeds to the third growing location 610 and not to the fourth growing location 612. In another instance, the controller 148 apportions a greater amount of soybean seeds to the third growing location 610 and a lesser amount to the fourth growing location 612. In a still further example, there are one or more other growing locations that have higher commercial desirability indices than the third growing location 610 and the fourth growing location 612, and no seeds are apportioned to third growing location 610 and the fourth growing location 612.

In implementations, a variety of analytical devices can make use of the structures, techniques, approaches, and so on described herein. Thus, although systems 100 are described herein, a variety of analytical instruments may make use of the described techniques, approaches, structures, and so on. These devices may be configured with limited functionality (e.g., thin devices) or with robust functionality (e.g., thick devices). Thus, a device's functionality may relate to the device's software or hardware resources, e.g., processing power, memory (e.g., data storage capability), analytical ability, and so on.

Generally, any of the functions described herein can be implemented using hardware (e.g., fixed logic circuitry such as integrated circuits), software, firmware, manual processing, or a combination thereof. Thus, the blocks discussed in the above disclosure generally represent hardware (e.g., fixed logic circuitry such as integrated circuits), software, firmware, or a combination thereof. In the instance of a hardware configuration, the various blocks discussed in the above disclosure may be implemented as integrated circuits along with other functionality. Such integrated circuits may include all of the functions of a given block, system, or circuit, or a portion of the functions of the block, system, or circuit. Further, elements of the blocks, systems, or circuits may be implemented across multiple integrated circuits. Such integrated circuits may comprise various integrated circuits, including, but not necessarily limited to: a monolithic integrated circuit, a flip chip integrated circuit, a multichip module integrated circuit, and/or a mixed signal integrated circuit. In the instance of a software implementation, the various blocks discussed in the above disclosure represent executable instructions (e.g., program code) that perform specified tasks when executed on a processor. These executable instructions can be stored in one or more tangible computer readable media. In some such instances, the entire system, block, or circuit may be implemented using its software or firmware equivalent. In other instances, one part of a given system, block, or circuit may be implemented in software or firmware, while other parts are implemented in hardware.

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A method of determining an apportionment for a fixed amount of agricultural products to a first plurality of growing locations for a first growing season based upon a plurality of growing performances of at least one of the first plurality of growing locations or a second plurality of growing locations different from or overlapping with the first plurality of growing locations, the method comprising:
remotely collecting a first plurality of intrinsic attributes for a first growing location;
remotely collecting a first plurality of extrinsic attributes for the first growing location, each one of the first plurality of extrinsic attributes associated with a second growing season prior to the first growing season;
mechanistically modeling a life cycle stage timing and a field productivity for the first growing location based upon the first plurality of intrinsic attributes and the first plurality of extrinsic attributes;
temporally shifting at least one attribute of the first plurality of intrinsic attributes or the first plurality of extrinsic attributes based upon the mechanistic modeling of the life cycle stage time and the field productivity for the first growing location;
determining an aggregate commercial desirability for a first plurality of crop samples grown in the first growing location based upon a commercial processing of the first plurality of crop samples, the first plurality of crop samples grown in the first growing location during the second growing season;
remotely collecting a second plurality of intrinsic attributes for a second growing location;
remotely collecting a second plurality of extrinsic attributes for the second growing location, each one of the second plurality of extrinsic attributes associated with the second growing season;
mechanistically modeling a life cycle stage timing and a field productivity for the second growing location based upon the second plurality of intrinsic attributes and the second plurality of extrinsic attributes;
temporally shifting at least one attribute of the second plurality of intrinsic attributes or the second plurality of extrinsic attributes based upon the mechanistic modeling of the life cycle stage time and the field productivity for the second growing location;
determining an aggregate commercial desirability for a second plurality of crop samples grown in the second growing location based upon a commercial processing of the second plurality of crop samples, the second plurality of crop samples grown in the second growing location during the second growing season;
normalizing the aggregate commercial desirability of the first plurality of crop samples and the aggregate commercial desirability of the second plurality of crop samples with respect to one another to establish a first commercial desirability index and a second commercial desirability index, respectively;
training a controller to identify a subset of attributes selected from the first plurality of intrinsic attributes and the first plurality of extrinsic attributes for the first growing location, and the second plurality of intrinsic attributes and the second plurality of extrinsic attributes for the second growing location, and correlated with the first commercial desirability index and the second commercial desirability index, respectively;
remotely collecting a third plurality of intrinsic attributes for a third growing location;
remotely collecting a third plurality of extrinsic attributes for the third growing location, each one of the third plurality of extrinsic attributes associated with the first growing season;
predicting, by the trained controller, a third commercial desirability index for the third growing location specific to the first growing season based upon the subset of attributes;
remotely collecting a fourth plurality of intrinsic attributes for a fourth growing location;
remotely collecting a fourth plurality of extrinsic attributes for the fourth growing location, each one of the fourth plurality of extrinsic attributes associated with the first growing season;
predicting, by the trained controller, a fourth commercial desirability index for the fourth growing location specific to the first growing season based upon the subset of attributes; and
determining an apportionment for a fixed amount of agricultural products to at least one of the third growing location or the fourth growing location for the first growing season based upon the predicted third commercial desirability index and the predicted fourth commercial desirability index.

2. The method as recited in claim 1, wherein the first plurality of intrinsic attributes comprises at least one of a soil quality, an elevation, or a latitude.

3. The method as recited in claim 1, wherein the first plurality of intrinsic attributes comprises a distance from at least one of a crop processing facility or a crop storage facility.

4. The method as recited in claim 1, wherein the first plurality of intrinsic attributes comprises a unit cost of at least one of a crop processing facility or a crop storage facility.

5. The method as recited in claim 1, wherein the first plurality of extrinsic attributes comprises an agronomic management attribute.

6. The method as recited in claim 1, wherein the first plurality of extrinsic attributes comprises at least one of a weather attribute or a climate attribute.

7. The method as recited in claim 1, wherein the first plurality of extrinsic attributes comprises satellite data.

8. The method as recited in claim 7, wherein the satellite data comprises spectral reflectance data.

9. The method as recited in claim 8, further comprising deriving a dynamic soil condition from the spectral reflectance data.

10. The method as recited in claim 8, further comprising deriving a field productivity from the spectral reflectance data.

11. The method as recited in claim 8, further comprising deriving a crop identification from the spectral reflectance data.

12. The method as recited in claim 1, wherein the first plurality of extrinsic attributes comprises at least one of a fertilizer or a microbial.

13. The method as recited in claim 1, wherein the first plurality of extrinsic attributes comprises a climate simulation model prediction.

14. The method as recited in claim 1, wherein determining an aggregate commercial desirability for a first plurality of crop samples grown in the first growing location comprises at least one of determining an amount of protein extracted from the first plurality of crop samples, determining an amount of oil extracted from the first plurality of crop samples, or determining an amount of profit generated by the first plurality of crop samples.

15. The method as recited in claim 1, wherein training a controller to identify a subset of attributes selected from the first plurality of intrinsic attributes and the first plurality of extrinsic attributes for the first growing location, and the second plurality of intrinsic attributes and the second plurality of extrinsic attributes for the second growing location, and correlated with the first commercial desirability index and the second commercial desirability index, respectively, comprises machine learning.

16. The method as recited in claim 15, wherein machine learning comprises deep learning.

17. The method as recited in claim 1, wherein the first growing location and one of the third growing location or the fourth growing location are the same location.

18. The method as recited in claim 17, wherein the second growing location and the other of the third growing location or the fourth growing location are the same location.

19. A method of determining an apportionment for a fixed amount of agricultural products to a first plurality of growing locations for a first growing season based upon a plurality of growing performances of at least one of the first plurality of growing locations or a second plurality of growing locations different from or overlapping with the first plurality of growing locations, the method comprising:
remotely collecting a first plurality of intrinsic attributes for a first growing location;
remotely collecting a first plurality of extrinsic attributes for the first growing location, each one of the first plurality of extrinsic attributes associated with a second growing season prior to the first growing season;
determining an aggregate commercial desirability for a first plurality of crop samples grown in the first growing location based upon a commercial processing of the first plurality of crop samples, the first plurality of crop samples grown in the first growing location during the second growing season;
remotely collecting a second plurality of intrinsic attributes for a second growing location;
remotely collecting a second plurality of extrinsic attributes for the second growing location, each one of the second plurality of extrinsic attributes associated with the second growing season;
determining an aggregate commercial desirability for a second plurality of crop samples grown in the second growing location based upon a commercial processing of the second plurality of crop samples, the second plurality of crop samples grown in the second growing location during the second growing season;
normalizing the aggregate commercial desirability of the first plurality of crop samples and the aggregate commercial desirability of the second plurality of crop samples with respect to one another to establish a first commercial desirability index and a second commercial desirability index, respectively;
training a controller to identify a subset of attributes selected from the first plurality of intrinsic attributes and the first plurality of extrinsic attributes for the first growing location, and the second plurality of intrinsic attributes and the second plurality of extrinsic attributes for the second growing location, and correlated with the first commercial desirability index and the second commercial desirability index, respectively;
remotely collecting a third plurality of intrinsic attributes for a third growing location;
remotely collecting a third plurality of extrinsic attributes for the third growing location, each one of the third plurality of extrinsic attributes associated with the first growing season;
predicting, by the trained controller, a third commercial desirability index for the third growing location specific to the first growing season based upon the subset of attributes;
remotely collecting a fourth plurality of intrinsic attributes for a fourth growing location;
remotely collecting a fourth plurality of extrinsic attributes for the fourth growing location, each one of the fourth plurality of extrinsic attributes associated with the first growing season;
predicting, by the trained controller, a fourth commercial desirability index for the fourth growing location specific to the first growing season based upon the subset of attributes; and
determining an apportionment for a fixed amount of agricultural products to at least one of the third growing location or the fourth growing location for the first growing season based upon the predicted third commercial desirability index and the predicted fourth commercial desirability index.

20. A system for determining an apportionment for a fixed amount of agricultural products to a first plurality of growing locations for a first growing season based upon a plurality of growing performances of at least one of the first plurality of growing locations or a second plurality of growing locations different from or overlapping with the first plurality of growing locations, the system comprising:
a first plurality of sensors for remotely collecting a first plurality of intrinsic attributes and a first plurality of extrinsic attributes for a first growing location, each one of the first plurality of extrinsic attributes associated with a second growing season prior to the first growing season;
a second plurality of sensors for remotely collecting a second plurality of intrinsic attributes and a second plurality of extrinsic attributes for a second growing location, each one of the second plurality of extrinsic attributes associated with the second growing season;
a third plurality of sensors for remotely collecting a third plurality of intrinsic attributes and a third plurality of extrinsic attributes for a third growing location, each one of the third plurality of extrinsic attributes associated with the first growing season;
a fourth plurality of sensors for remotely collecting a fourth plurality of intrinsic attributes and a fourth plurality of extrinsic attributes for a fourth growing location, each one of the fourth plurality of extrinsic attributes associated with the first growing season; and
a controller configured to:
receive an aggregate commercial desirability for a first plurality of crop samples grown in the first growing location based upon a commercial processing of the first plurality of crop samples, the first plurality of crop samples grown in the first growing location during the second growing season;
receive an aggregate commercial desirability for a second plurality of crop samples grown in the second growing location based upon a commercial processing of the second plurality of crop samples, the second plurality of crop samples grown in the second growing location during the second growing season;
normalize the aggregate commercial desirability of the first plurality of crop samples and the aggregate commercial desirability of the second plurality of crop samples with respect to one another to establish a first commercial desirability index and a second commercial desirability index, respectively;
identify a subset of attributes selected from the first plurality of intrinsic attributes and the first plurality of extrinsic attributes for the first growing location, and the second plurality of intrinsic attributes and the second plurality of extrinsic attributes for the second growing location, and correlated with the first commercial desirability index and the second commercial desirability index, respectively;
predict a third commercial desirability index for the third growing location specific to the first growing season based upon the subset of attributes;
predict a fourth commercial desirability index for the fourth growing location specific to the first growing season based upon the subset of attributes; and
determine an apportionment for a fixed amount of agricultural products to at least one of the third growing location or the fourth growing location for the first growing season based upon the predicted third commercial desirability index and the predicted fourth commercial desirability index.

21. A method of determining an apportionment for a fixed amount of agricultural products to a first plurality of growing locations for a first growing season based upon a plurality of growing performances of at least one of the first plurality of growing locations or a second plurality of growing locations different from or overlapping with the first plurality of growing locations, the method comprising:
remotely collecting a first plurality of intrinsic attributes for a first growing location;
remotely collecting a first plurality of extrinsic attributes for the first growing location, each one of the first plurality of extrinsic attributes associated with a second growing season prior to the first growing season;
mechanistically modeling a life cycle stage timing and a field productivity for the first growing location based upon the first plurality of intrinsic attributes and the first plurality of extrinsic attributes;
temporally shifting at least one attribute of the first plurality of intrinsic attributes or the first plurality of extrinsic attributes based upon the mechanistic modeling of the life cycle stage time and the field productivity for the first growing location;
determining an aggregate commercial desirability for a first plurality of crop samples grown in the first growing location based upon a commercial processing of the first plurality of crop samples, the first plurality of crop samples grown in the first growing location during the second growing season;
remotely collecting a second plurality of intrinsic attributes for a second growing location;
remotely collecting a second plurality of extrinsic attributes for the second growing location, each one of the second plurality of extrinsic attributes associated with the second growing season;
mechanistically modeling a life cycle stage timing and a field productivity for the second growing location based upon the second plurality of intrinsic attributes and the second plurality of extrinsic attributes;
temporally shifting at least one attribute of the second plurality of intrinsic attributes or the second plurality of extrinsic attributes based upon the mechanistic modeling of the life cycle stage time and the field productivity for the second growing location;
determining an aggregate commercial desirability for a second plurality of crop samples grown in the second growing location based upon a commercial processing of the second plurality of crop samples, the second plurality of crop samples grown in the second growing location during the second growing season;
normalizing the aggregate commercial desirability of the first plurality of crop samples and the aggregate commercial desirability of the second plurality of crop samples with respect to one another to establish a first commercial desirability index and a second commercial desirability index, respectively; and
training a controller to identify a subset of attributes selected from the first plurality of intrinsic attributes and the first plurality of extrinsic attributes for the first growing location, and the second plurality of intrinsic attributes and the second plurality of extrinsic attributes for the second growing location, and correlated with the first commercial desirability index and the second commercial desirability index, respectively, for determining an apportionment for a fixed amount of agricultural products to the first plurality of growing locations for the first growing season.
